(19) United States
(12) Patent Application Publication
(10) Pub. No.: US 2024/0366984 A1
(43) Pub. Date: Nov. 7, 2024

(54) FIRE-FIGHTING FOAM COMPOSITION

(71) Applicant: Tyco Fire Products LP, Cranston, RI (US)

(72) Inventors: Robert A. Chaltry, Porterfield, WI (US); JoAnna M. Monfils, Peshtigo, WI (US); John P. Libal, Peshtigo, WI (US)

(73) Assignee: Tyco Fire Products LP, Cranston, RI (US)

(21) Appl. No.: 18/683,993

(22) PCT Filed: Oct. 13, 2022
(86) PCT No.: PCT/IB2022/059798

§ 371 Date: Feb. 15, 2024

Related U.S. Application Data
(60) Provisional application No. 63/256,757, filed on Oct. 18, 2021.

(51) Int. Cl. A62D 1/02

(52) U.S. Cl. CPC A62D 1/0071

(57) ABSTRACT

An aqueous fluorine-free, fire-fighting composition including monosaccharide sugar and/or sugar alcohol, aliphatic anionic surfactant, zwitterionic surfactant, water-miscible organic solvent, and optionally alkanolamine, is provided. The fire-fighting composition commonly does not contain any amine oxide surfactant, nonionic surfactant, or polysaccharide thickener.

### CROSS-REFERENCE TO RELATED APPLICATIONS

This application claims the benefit of priority to U.S. Provisional Patent Application No. 63/256,757, filed on Oct. 18, 2021, the contents of which are incorporated herein by reference in their entirety.

### BACKGROUND

Firefighting foams are often deployed to suppress or extinguish Class B fires. Class B fires are those involving flammable liquid fuels, gasoline, and other hydrocarbons and are difficult to extinguish. Most flammable liquids exhibit high vapor pressure along with low fire and flash points. This typically results in a wide flammability range. In this type of fire, the use of water as the sole firefighting agent is generally ineffective because the only means of fighting fire with water is through cooling and the hydrophobic nature of the liquids involved may result in the water spreading the fuel around rather than extinguishing the fire.

Conventional foam-forming firefighting compositions commonly include fluorinated and perfluorinated surfactants. Environmental concerns related to fluorinated and perfluorinated surfactants have developed. As a result, there is a strong desire in the marketplace to replace fluorinated and perfluorinated firefighting products with non-fluorinated products. There is therefore a continuing need to produce fluorine-free AFFF firefighting compositions that can be deployed to effectively fight and suppress Class B fires.

### SUMMARY

The present application is directed to aqueous fire-fighting compositions, typically in the form of foam concentrates, which can be diluted with an aqueous diluent to provide a foam precursor composition. The more dilute foam precursor composition can be aerated to form a firefighting foam, which may be used to suppress vapors and/or fight a fire. The compositions may be particularly advantageous for use in forming foam to fight and/or suppress hydrocarbon or volatile solvent fires (e.g., Class B fires). The aqueous fire-fighting composition may include a sugar component, anionic surfactant, zwitterionic surfactant, organic solvent, and optionally alkanolamine. The compositions are commonly is substantially free of any amine oxide or nonionic surfactants and any fluorinated additives. Typically, such aqueous fire-fighting compositions do not contain any polysaccharide thickener.

In one aspect, an aqueous fluorine-free, fire-fighting foam composition is disclosed, which includes monosaccharide sugar and/or sugar alcohol, aliphatic anionic surfactant, zwitterionic surfactant, and a water-miscible organic solvent (e.g., a glycol and/or glycol ether solvent). Such a composition commonly is substantially free of and in many instances does not contain any amine oxide surfactant, nonionic surfactant, or polysaccharide thickener.

In one embodiment, the sugar component includes one or more of glucose, fructose, mannose, xylose, xylitol, sorbitol, and mannitol. In an embodiment, the foam includes at least about 5 wt. % and, more commonly, about 5 to 20 wt. % of the monosaccharide sugar and/or sugar alcohol.

In an embodiment, the anionic surfactant may include one or more of an aliphatic sulfate surfactant, an aliphatic sulfonate surfactant, an aliphatic succinate salt, and an aliphatic ether sulfate surfactant. In one embodiment, the anionic surfactant includes one or more of C₈-C₁₄ alkyl sulfate, C₈-C₁₄ alkyl sulfonate and C₁₀-C₁₄ alkyl ether sulfate. In some embodiments, the anionic surfactant includes one or more C₈-C₁₄ alkyl sulfates. In some embodiments, the anionic surfactant includes a decyl sulfate salt and/or a lauryl sulfate salt. In some embodiments, the composition includes about 3 to 15 wt. % and, more commonly, about 5 to 12 wt. % of the anionic surfactant.

In some embodiments, the zwitterionic surfactant may include one or more of an aliphatic amidoalkyl betaine, an aliphatic sulfobetaine, an aliphatic amidoalkyl hydroxysultaine, and an aliphatic hydroxysultaine. In some embodiments, the zwitterionic surfactant includes an aliphatic amidoalkyl hydroxysultaine, such as an alkyl amidoalkyl hydroxysultaine. In some embodiments, the zwitterionic surfactant includes one or more C₈-C₁₄ alkyl amidopropyl hydroxysultaines. In some embodiments, the composition includes about 2 to 15 wt. % and, more commonly, about 2 to 12 wt. % of the zwitterionic surfactant.

In some embodiments, the water-miscible organic solvent includes alkylene glycol solvent and/or glycol ether solvent, e.g., a mixture of alkylene glycol and alkylene glycol monoalkyl ether solvents. In some embodiments, the water-miscible organic solvent includes ethylene glycol and diethylene glycol monobutyl ether. In some embodiments, the water-miscible organic solvent includes ethylene glycol, diethylene glycol monobutyl ether, and glycerin. In some embodiments, the composition includes about 5 to 25 wt. % and, more commonly, about 10 to 15 wt. % of the water-miscible organic solvent. In some embodiments, the water-miscible organic solvent includes one or more of diethylene glycol monobutyl ether, ethylene glycol monophenyl ether, dipropylene glycol monobutyl ether, dipropylene glycol monomethyl ether, 1,6-hexanediol, ethylene glycol, hexylene glycol, propylene glycol and glycerine.

In some embodiments, the fire-fighting foam composition may include alkanolamine, such as monoethanolamine, diethanolamine, diisopropanolamine, and/or triethanolamine. In many instances, where the fire-fighting foam composition includes an alkanolamine, it may advantageously include triethanolamine. In some embodiments, the composition includes about 1 to 10 wt. % and, more commonly, about 2 to 7 wt. % alkanolamine.

In some embodiments, the composition also includes a divalent metal salt, such as a magnesium salt. In some of these embodiments, the divalent metal salt often includes magnesium sulfate although other suitable magnesium salts, e.g., magnesium acetate, may be utilized. In some embodiments, the composition includes about 0.2 to 3 wt. % or about 0.5 to 2 wt. % of the magnesium salt.

In some embodiments, the fire-fighting foam composition may also include one or more of a chelator, a buffer, a corrosion inhibitor, and a preservative.

In another aspect, the aqueous fluorine-free, fire-fighting foam composition includes about 5 to 20 wt. % monosaccharide sugar, about 5 to 15 wt. % alkyl sulfate anionic surfactant, about 2 to 10 wt. % alkylamidoalkyl hydroxysultaine surfactant, about 3 to 8 wt. % alkylene glycol, about 4 to 12 wt. % alkylene glycol monoalkyl ether, about 2 to 7 wt. % alkanolamine, and about 0.2 to 3 wt. % magnesium salt. Such a composition commonly does not contain any amine oxide or nonionic surfactant or polysaccharide thickener.

In another aspect, the aqueous fluorine-free, fire-fighting foam composition includes about 5 to 20 wt. % glucose and/or fructose, about 5 to 15 wt. % of one or more C₈-C₁₄ alkyl sulfate anionic surfactants, about 5 to 15 wt. % cocamidopropyl hydroxysultaine, about 3 to 8 wt. % ethylene glycol, about 4 to 12 wt. % diethylene glycol monobutyl ether, about 2 to 7 wt. % triethanolamine, and about 0.2 to 3 wt. % magnesium sulfate. Such compositions commonly do not contain any amine oxide or nonionic surfactant or polysaccharide thickener.

In another aspect, the aqueous fluorine-free, fire-fighting foam composition includes glucose and/or fructose, decyl sulfate and/or lauryl sulfate anionic surfactants, cocamidopropyl hydroxysultaine, ethylene glycol, diethylene glycol monobutyl ether, triethanolamine, and magnesium sulfate. Such compositions commonly do not contain any amine oxide or nonionic surfactant or polysaccharide thickener.

In another aspect, the aqueous fluorine-free, fire-fighting foam composition includes one or more monosaccharide sugars, one or more alkyl sulfate anionic surfactants, one or more alkyl amidopropyl hydroxysultaines, alkylene glycol, dialkylene glycol monoalkyl ether, alkanolamine and magnesium salt. Such compositions commonly do not contain any amine oxide or nonionic surfactant or polysaccharide thickener.

In any of the foregoing embodiments, the sugars used in the composition may contain a total of no more than about 10 wt. % disaccharide sugars and oligosaccharides (as a percentage of the total weight of all of the sugar components). In any of the foregoing embodiments, the sugars used in the composition may contain at least about 75 wt. % and, often, at least about 85 wt. % of one or more monosaccharide sugars (as a percentage of the total weight of all of the sugar components). Typically, the sugar component contains a total of no more than about 10 wt. % and, often, no more than about 5 wt. % disaccharide sugars and oligosaccharides (as a percentage of the total weight of the sugar component).

In any of the foregoing embodiments, the composition may include one or more of a chelator, a buffer, a corrosion inhibitor, and a preservative. In any of the foregoing embodiments, the composition may have a pH of about 7 to 9. In any of the foregoing embodiments, the composition desirably may have no more than about 0.01% wt. % fluorinated additives. In any of the foregoing embodiments, the composition may be produced so as to have a fluorine content of no more than about lppm F.

In another aspect, a method of forming a firefighting foam includes aerating a foam precursor composition comprising the aqueous fluorine-free, fire-fighting foam composition of any of foregoing foam composition embodiments to form the firefighting foam.

In another aspect, a method of forming a firefighting foam includes mixing the firefighting foam composition of any of the foregoing foam composition embodiments with an aqueous diluent to form a foam precursor solution, and aerating the foam precursor solution to form the firefighting foam.

### DETAILED DESCRIPTION

In one aspect, the aqueous firefighting foam compositions of the present disclosure include a sugar component, which commonly includes a monosaccharide sugar and/or sugar alcohol; a surfactant component, which comprises anionic surfactant and a zwitterionic surfactant; a water-miscible organic solvent; and optionally an alkanolamine. Such compositions generally are substantially free of fluorinated additives, e.g., contain no more than 0.1 wt. % fluorinated surfactant and, often, are completely free (i.e., contains no more than 0.01 wt. %) of any fluorinated surfactant or other fluorinated additive. Such compositions typically do not contain any amine oxide surfactant, nonionic surfactant, or polysaccharide thickener.

Sugars and/or sugar alcohols suitable for use in the present aqueous fire-fighting foam compositions are generally simple monosaccharide sugars or related sugar alcohols, but may include small amounts of other carbohydrates, such as common sugar (sucrose/dextrose) derived from sugar cane or sugar beets. Sucrose is a disaccharide composed from the basic, simple sugar molecules glucose and fructose. Mixtures where the majority of the sucrose has been broken down into its monosaccharide components, glucose and fructose (e.g., invert sugar), are quite suitable for use in the present compositions. Quite commonly, the sugar component may contain at least about 75 wt. %, or more preferably at least 85 wt. % monosaccharide sugars and/or sugar alcohols. The sugar component suitably contains at least about 75 wt. %, or often at least about 85 wt. % and, in some instances, at least about 90 wt. % monosaccharide sugars, such as glucose and/or fructose. The sugar component typically contains a total of no more than about 10 wt. % and, often no more than about 5 wt. % disaccharide sugars and oligosaccharides (as a percentage of the total weight of the sugar component).

Sucrose and related monosaccharides (fructose and glucose) are readily available in view of its world production from sugar cane and sugar beets on the order of millions of tons per annum. Those skilled in the art will also understand that other commercially available simple monosaccharides and related sugar alcohols can be utilized in the present foam compositions. Examples of suitable monosaccharides for use in the present foam compositions include one or more of glucose, fructose, mannose, xylose, and galactose. Examples of suitable sugar alcohols for use in the present foam compositions include one or more of a four carbon sugar alcohol, such as erythritol, a five carbon alditol, such as xylitol, a six carbon alditol, such as mannitol and/or sorbitol, and other sugar alcohols, such as isomalt. Commonly, the sugar alcohol is one derived from a monosaccharide.

The present aqueous fire-fighting foam compositions generally include a sugar component including at least about 75 wt. %, at least about 85 wt. % and, in many instances at least about 90 wt. % of one or more monosaccharide sugars and/or sugar alcohols. Suitable examples include such a sugar component containing one or more of glucose, fructose, mannose, xylose, sorbitol, xylitol, and mannitol. The foam composition commonly includes about 5 to 25 wt. % and, often, about 5 to 20 wt. % of the sugar component. In some instances, the foam composition may include about 10 wt. % to 15 wt. % of the sugar component. In some embodiments, the sugar component includes at least about 75 wt. %, at least about 80 wt. %, or even at least about 90 wt. % monosaccharide sugar and/or sugar alcohol. For example, the sugar component may comprise at least about 75 wt. %, at least about 80 wt. %, at least about 85 wt. %, or even at least about 90 wt. % of one or more of glucose, fructose, mannose, xylitol, sorbitol, and mannitol. In some embodiments, the foam composition may include a sugar component, which comprises at least about 75 wt. % of one or more sugar alcohols, such as xylitol, sorbitol, and mannitol. Advantageously, the sugar component may include at least about 75 wt. %, at least about 80 wt. %, at least about 85 wt. %, or even at least about 90 wt. % of one or more of glucose, fructose, and sorbitol. For example, the sugar component may include at least about 75 wt. % and, more commonly, at least about 85 wt. % or even at least about 90 wt. % glucose and/or fructose.

The present aqueous fire-fighting foam compositions typically include an anionic surfactant. The anionic surfactant may suitably include an aliphatic sulfate surfactant, an aliphatic sulfonate surfactant, aliphatic ether sulfate surfactant, and/or an aliphatic ether sulfonate surfactant. The anionic surfactant may suitably include an alkyl sulfate surfactant, an alkyl sulfonate surfactant, alkyl ether sulfate surfactant and/or an alkyl ether sulfonate surfactant. The anionic surfactant typically includes an alkyl sulfate surfactant and/or an alkyl sulfonate surfactant. The alkyl sulfate salt surfactant typically includes include a C₈₋₁₂-alkyl sulfate salt. Suitable examples of the C₈₋₁₂-alkyl sulfate salt include a dodecyl sulfate salt (lauryl sulfate salt), a decyl sulfate salt, an octyl sulfate salt, or a combination of any two or more thereof. In some embodiments, the alkyl sulfate salt includes an alkyl sulfate sodium salt, such as a sodium decyl sulfate, sodium octyl sulfate, or a combination thereof. In some embodiments, the alkyl sulfate salt includes an alkyl sulfate ammonium salt, such as an ammonium decyl sulfate, ammonium octyl sulfate, ammonium lauryl sulfate, triethanolamine lauryl sulfate salt, or a combination thereof. In embodiments that include the anionic surfactant, the aqueous firefighting foam composition may include about 1 to 25 wt. % or about 2 to 20 wt. % of the anionic surfactant. Typically, the aqueous firefighting foam composition commonly includes about 3 to 15 wt. %, about 5 to 12 wt. % and, in some instances, about 5 to 10 wt. % of a the anionic surfactant.

In some embodiments, the aqueous fire-fighting foam composition may include an anionic surfactant which comprises a C₈₋₁₄-alkyl sulfate salt and/or a C₈₋₁₄-alkyl sulfonate salt. In some embodiments, the aqueous fire-fighting foam composition may include an anionic surfactant, which comprises one or more surfactants selected from C₈₋₁₂-alkyl sulfate salts and/or a C₈₋₁₂-alkyl sulfonate salts. For example, one or more of octyl sulfate salts, decyl sulfate salts, dodecyl sulfate salts, and tetradecyl sulfate salts may be suitable for use as anionic surfactants in the present foam composition. The anionic surfactant may suitably be a sodium, potassium, and/or ammonium salt (e.g., an NH₄+ or trialkyl ammonium salt).

In some embodiments, the aqueous fire-fighting foam composition may include an anionic surfactant comprising a C₈₋₁₄-alkyl sulfate amine salt. In some embodiments, the aqueous fire-fighting foam composition may include an anionic surfactant, which comprises one or more surfactants selected from C₈₋₁₂-alkyl sulfate amine salts and/or a C₈₋₁₂-alkyl sulfonate amine salts. For example, one or more of triethanolamine octyl sulfate salts, triethanolamine decyl sulfate salts, triethanolamine dodecyl sulfate salts, and triethanolamine tetradecyl sulfate salts may be suitable for use as anionic surfactants in the present fire-fighting foam composition.

The present aqueous fire-fighting foam compositions typically include a zwitterionic surfactant. The zwitterionic surfactant may suitably include one or more of an aliphatic amidoalkyl betaine surfactant, an aliphatic betaine surfactant, an aliphatic sulfobetaine surfactant and an aliphatic amidoalkylene hydroxysultaine surfactant, such as an aliphatic amidopropyl hydroxysultaine surfactant. The zwitterionic surfactant may include one or more of an alkylamidoalkyl betaine surfactant, an alkyl betaine surfactant, an alkyl sulfobetaine surfactant and an alkylamidoalkylene hydroxysultaine surfactant, such as an alkylamidopropyl hydroxysultaine surfactant. For example, the foam composition may include a zwitterionic surfactant, which comprises one or more of a C₈₋₁₈-alkylamidopropyl hydroxysultaine surfactant, a C₈₋₁₈-alkylamidopropyl betaine surfactant a C₈₋₁₄-alkyl sulfobetaine surfactant and a C₈₋₁₈-alkyl betaine surfactant. Suitable examples of the alkylamidoalkylene hydroxysultaine surfactant include a C₈₋₁₄-alkylamidopropyl hydroxysultaine surfactant, such as a cocamidopropyl hydroxysultaine surfactant, which includes a laurylamidopropyl hydroxysultaine and a myristylamidopropyl hydroxysultaine. Suitable examples of the alkylamidoalkyl betaine surfactant include a C₈₋₁₈-alkylamidoalkyl betaine surfactant, such as a cocamidopropyl betaine, a tallowamidopropyl betaine, a laurylamidopropyl betaine, or a myristylamidopropyl betaine. In some embodiments, the zwitterionic surfactant includes a C₈₋₁₄-alkylamidopropyl hydroxysultaine, such as a cocamidopropyl hydroxysultaine. In some embodiments, the zwitterionic surfactant includes laurylamidopropyl hydroxysultaine and/or myristylamidopropyl hydroxysultaine. In embodiments that include the zwitterionic surfactant, the aqueous firefighting foam composition commonly includes about 1 to 15 wt. % and often about 1 to 12 wt. % of the zwitterionic surfactant. In certain embodiments, the aqueous firefighting foam composition may include about 1 to 10 wt. % and, more commonly, about 3 to 9 wt. % of the zwitterionic surfactant.

The present aqueous fire-fighting foam compositions desirably may be are substantially free of and many instances do not include any amine oxide or nonionic surfactants. Substantially free in this context means that the aqueous fire-fighting foam compositions include no more than 0.1 wt. % amine oxide or nonionic surfactant. In some instances, the aqueous fire-fighting foam compositions include no more than 0.01 wt. % amine oxide or nonionic surfactant.

The present aqueous fire-fighting foam compositions typically include a water-miscible solvent, which may suitably include one or more of a glycol, a glycol ether, glycerol, and a water-soluble polyethylene glycol. Examples of suitable organic solvents include diethylene glycol n-butyl ether, dipropylene glycol n-propyl ether, hexylene glycol, ethylene glycol, propylene glycol, diethylene glycol, dipropylene glycol, tripropylene glycol, dipropylene glycol monobutyl ether, dipropylene glycol monomethyl ether, diethylene glycol monobutyl ether (“butyl carbitol”), ethylene glycol monobutyl ether, tripropylene glycol monomethyl ether, dipropylene glycol monoethyl ether, glycerol, and mixtures of two or more thereof. Quite commonly, the organic solvent includes a mixture of glycerol (glycerine), an alkylene glycol, and a glycol ether, such as a glycol butyl ether. In some embodiments, the organic solvent includes an alkylene glycol ether, such as ethylene glycol monoalkyl ether, propylene glycol monoalkyl ether, dipropylene glycol monoalkyl ether (e.g., diethylene glycol monoalkyl ether (e.g., butyl carbitol). In some embodiments, the organic solvent includes an alkylene glycol, such as ethylene glycol, propylene glycol, dipropylene glycol and/or diethylene glycol. In some embodiments, the organic solvent includes a polyol, such as glycerine. Quite commonly, the organic solvent may include a mixture of butyl carbitol, a glycol ether, such as ethylene glycol and/or propylene glycol, and glycerine. For example, the organic solvent can include glycerine, ethylene glycol, and butyl carbitol. In another suitable example, the organic solvent includes glycerine, propylene glycol, and butyl carbitol.

In some instances, the organic solvent in the present compositions may include one or more of 1,6-hexanediol, hexylene glycol, ethyleneglycol monophenyl ether, butyl carbitol, 1,12-dodecanediol and dipropylene glycol monobutyl ether. For example, the organic solvent may include a combination of 1,6-hexanediol and dipropylene glycol monobutyl ether. In another suitable example, the organic solvent may include a combination of 1,6-hexanediol, ethyleneglycol, butyl carbitol and dipropylene glycol monobutyl ether. In another suitable example, the organic solvent may include a combination of 1,6-hexanediol, dipropylene glycol monobutyl ether and ethyleneglycol monophenyl ether. In another suitable example, the organic solvent may include a combination of 1,6-hexanediol, 1,12-dodecanediol, ethyleneglycol monophenyl ether and dipropylene glycol monobutyl ether. In another suitable example, the organic solvent may include a combination of 1,12-dodecanediol, ethyleneglycol monophenyl ether and dipropylene glycol monobutyl ether. In another suitable example, the organic solvent may include a combination of 1,6-hexanediol, 1,12-dodecanediol and ethyleneglycol monophenyl ether.

The foam composition may suitably include about 1 to 50 wt. %, commonly, about 1 to 25 wt. %, about 1 to 20 wt. %, often about 2 to 15 wt. % and, in some instances, about 5 to 10 wt. % organic solvent. In many embodiments, the aqueous firefighting foam composition includes an organic solvent including one or more of an alkylene glycol, glycerine, and a glycol ether. The alkylene glycol may include 1,6-hexanediol, 1,12-dodecanediol, propylene glycol and/or ethylene glycol. The glycol ether typically includes ethylene glycol monoalkyl ether, diethylene glycol monoalkyl ether, dipropylene glycol monoalkyl ether, triethylene glycol monoalkyl ether, ethyleneglycol monophenyl ether, and 1-butoxyethoxy-2-propanol. In some embodiments, the organic solvent may be a mixture of glycerine, alkylene glycol and glycol ether. In some embodiments, the organic solvent may be a mixture of glycerine, propylene glycol, and alkyl carbitol. In some embodiments, the organic solvent may be a mixture of glycerine, ethylene glycol, and alkyl carbitol. In such embodiments, the organic solvent commonly includes the alkylene glycol and alkyl carbitol in a weight ratio of about 0.1:1 to 10:1 or about 0.2:1 to 5:1. In some embodiments, the organic solvent may be a mixture of glycerine, ethylene glycol, and butyl carbitol. In some embodiments, the organic solvent may include about 1 to 15 wt. % and often about 1 to 10 wt. % alkylene glycol, such as ethylene glycol, with about 1 to 15 wt. % and often about 1 to 10 wt. % of a glycol ether, such as butyl carbitol, together with about 0.1 to 5 wt. % or about 0.1 to 2 wt. % glycerol.

In many instances, the present aqueous firefighting foam composition may include an alkanolamine, which can act as a pH adjusting agent and/or buffer. Suitable alkanolamines comprise monoethanolamine, diethanolamine, diisopropanolamine, and/or triethanolamine. Quite commonly, the present compositions may include triethanolamine. The triethanolamine may be present in only a relatively small amount, e.g., about 0.1 to 0.3 wt. % when included primarily as a pH adjusting agent. In other instances, the alkanolamine may be present in a higher amount, whether introduced per se as an ingredient and/or in the form of a cation as part of one of the surfactants present in the composition. In such instances, an alkanolamine, such as triethanolamine, may suitably be present as about 2 to 10 wt. %, about 3 to 10 wt. %, about 3 to 8 wt. %, and in some instances, about 3 to 7 wt. % of the composition.

As discussed above, the aqueous firefighting foam composition includes water. In some embodiments, the water is water from a municipal water source (e.g., tap water). In some embodiments, the water is a purified water, such as purified water that meets the standards set forth in the United States Pharmacopeia, which is incorporated by reference herein in relevant part. In some embodiments, the aqueous firefighting foam composition includes at least about 30 wt. % water, often at least about 40 wt. % water and, more commonly, at least about 50 wt. % water. In some embodiments, the aqueous firefighting foam composition includes up to about 60 wt. % or even 65 wt. % water. In some embodiments, the aqueous firefighting foam composition may desirably be produced using a source of water that has a total concentration of fluorine atoms on a weight percentage basis of no more than about 1 ppm F.

The aqueous firefighting foam compositions of the present disclosure are commonly substantially free of any fluorinated additives. As used herein, the “phrase substantially free of fluorinated additives” means that the aqueous firefighting foam composition includes no more than 0.1 wt. % of fluorinated additives. In some embodiments, the aqueous firefighting foam composition includes no more than 0.01 wt. % of fluorinated additives. In some instances, the aqueous firefighting foam compositions of the present disclosure are free of fluorine. As used herein, the phrase “free of fluorine” means that the composition has a total concentration of fluorine atoms on a weight percentage basis of no more than about 100 part per million (ppm). In some instances, the present compositions contain no more than about 1 part per million (ppm) F. The aqueous firefighting foam compositions of the present disclosure may preferably include substantially less than 1 ppm F.

The aqueous firefighting foam compositions of the present disclosure are commonly substantially free of any polysaccharide thickeners. As used herein, the “phrase substantially free of polysaccharide thickeners” means that the aqueous firefighting foam composition includes no more than 0.1 wt. % polysaccharide thickener(s). In some instances, no more than 0.01 wt. % polysaccharide thickener(s).

In some embodiments, the aqueous firefighting foam composition may include one or more chelators or sequestering buffers. Exemplary and non-limiting chelators and sequestering buffers include agents that sequester and chelate metal ions, including polyamminopolycarboxylic acids, ethylenediaminetetraacetic acid, citric acid, tartaric acid, nitrilotriacetic acid, hydroxyethylethylenediaminetriacetic acid, and salts thereof. Exemplary buffers include phosphate and citrate buffers.

In some embodiments, the aqueous firefighting foam composition may include one or more corrosion inhibitors. Exemplary and non-limiting corrosion inhibitors includes ortho-phenylphenol, tolyltriazole, and phosphate ester acids. In some embodiments, the corrosion inhibitor is tolyltriazole.

In some embodiments, the aqueous firefighting foam concentrate may also include a metallic salt, typically a metallic salt which includes a multi-valent cation. For example, suitable salts may include a cation selected from the group consisting of aluminum, calcium, copper, iron, magnesium, potassium, and calcium cations. The counteranion may suitably be a sulfate, acetate and/or phosphate anion. In one embodiment, the metallic salt may include a divalent salt, e.g., a magnesium salt, such as magnesium sulfate or magnesium acetate. When included, a divalent salt, such as magnesium sulfate, may suitably be present as about 0.1 to 5 wt. %, about 0.2 to 3 wt. %, about 0.5 to 3 wt. % and in some instances, about 0.5 to 2 wt. % of the composition.

In some embodiments, the aqueous firefighting foam concentrate may also include a preservative, such as one or more antimicrobial additives and/or biocidal additives. These components are included to prevent the biological decomposition of natural product based polymers that are incorporated as polymeric film formers (e.g., a polysaccharide gum). Examples include Kathon CG/ICP (Rohm & Haas Company), Givgard G-4 40 (Givaudan, Inc.), Dowicil 75 and Dowacide A (Dow Chemical Company). In some instances, the biocidal agent in the present composition may include a phenol-based biocide, such as Dowacide A (sodium o-phenylphenate).

Tables 1 to 4 below provide an illustration of suitable formulations of the present firefighting foam compositions designed to be combined with a diluent, then aerated and administered to fight a fire in the form of a firefighting foam.

TABLE 1

| | Amount |
|---|---|
| Ingredient | (wt. %) |
| Biocide | 0-0.2 |
| Corrosion inhibitor | 0-0.2 |
| Zwitterionic surfactant | 2-15 |
| Anionic surfactant | 3-15 |
| Water-miscible organic solvent | 5-25 |
| Divalent metal salt | 0-5 |
| Monosaccharide sugar(s) | 5-20 |
| and/or sugar alcohol(s) | |
| Water | 30-80 |

TABLE 2

| | Amount |
|---|---|
| Ingredient | (wt. %) |
| Biocide | 0-0.2 |
| Corrosion inhibitor | 0-0.2 |
| Alkyl sulfate anionic surfactant | 3-15 |
| Alkyl amidoalkyl hydroxysultaine | 3-15 |
| Glycol ether solvent | 2-15 |
| Polyol solvent | 2-10 |
| Alkanolamine | 2-10 |
| Divalent metal salt | 0-5 |
| Monosaccharide sugar(s) | 5-20 |
| and/or sugar alcohol(s) | |
| Water | 40-75 |

TABLE 3

| | Amount |
|---|---|
| Ingredient | (wt. %) |
| Biocide | 0-0.2 |
| Corrosion inhibitor | 0-0.2 |
| C₈₋₁₄-Alkyl amidopropyl hydroxysultaine | 2-12 |
| C₁₀₋₁₂-Alkyl sulfate surfactant | 5-15 |
| Alkylene glycol | 2-10 |
| Glycol ether | 2-10 |
| Glycerine | 0-2 |
| Triethanolamine | 2-8 |
| Magnesium salt | 0.2-3 |
| Monosaccharide sugar(s) | 7-20 |
| Water | 40-65 |

TABLE 4

| | Amount |
|---|---|
| Ingredient | (wt. %) |
| Biocide | 0-0.2 |
| Corrosion Inhibitor | 0-0.2 |
| Cocamidopropyl hydroxysultaine | 3-10 |
| Decyl and/or lauryl sulfate surfactant | 5-12 |
| Glycerine | 0-2 |
| Ethylene glycol | 3-8 |
| Butyl carbitol | 4-12 |
| Triethanolamine | 2-7 |
| Magnesium sulfate | 0.2-3 |
| Glucose and/or fructose | 10-15 |
| Water | 40-65 |

### Examples

The following examples more specifically illustrate formulations for preparing aqueous firefighting compositions according to various embodiments described above. These examples should in no way be construed as limiting the scope of the present technology.

Table 5 below shows the composition of two exemplary formulations of the present aqueous firefighting foam composition. The amounts shown in the table represent the weight percentage of the particular component based on the total weight of the composition. The formulations include a) an anionic surfactant, b) a zwitterionic surfactant, c) organic solvent comprising an alkylene glycol, glycerol, and a glycol ether, d) a sugar component including a monosaccharide sugar or sugar alcohol, and e) a substantial amount of water. These exemplary formulations also include a divalent metal, such as a magnesium salt (e.g., magnesium sulfate). The exemplary formulations also include an alkanolamine, such as triethanolamine. These exemplary formulations may also include a preservative, an antimicrobial, and/or a corrosion inhibitor, though these ingredients are considered optional, and are not key to the composition functioning as a fire-fighting agent.

TABLE 5

| Component | Ex. A | Ex. B | Ex. C | Ex. D |
|---|---|---|---|---|
| Cocamidopropyl | 8.0 | 5.0 | 6.0 | 5.0 |
| Hydroxysultaine | | | | |
| Decyl Sulfate | 8.0 | — | 8.0 | — |
| TEA Lauryl Sulfate | — | 8.6 | — | 9.0 |
| TEA* | 5.0 | ~4.0* | 5.0 | ~4.0* |
| Ethylene glycol | 5.0 | 5.0 | 4.0 | 6.0 |
| Diethylene glycol monobutyl | 7.0 | 7.0 | 8.0 | 6.0 |
| ether | | | | |
| Glycerine | ~0.8 | ~0.5 | ~0.6 | ~0.5 |
| Glucose/fructose | ~13.5 | ~13.5 | ~14 | ~15 |
| Mg Sulfate | 0.6 | 0.6 | 0.7 | 0.6 |
| Preservative | 0.1 | 0.1 | 0.1 | 0.1 |
| Tolyltriazole | 0.05 | 0.05 | 0.05 | 0.05 |
| Water | ~51 | ~57 | ~53 | ~53 |

*includes triethanolamine (TEA) from the TEA lauryl sulfate surfactant

The present exemplary aqueous firefighting foam compositions, including the aqueous firefighting foam formulations shown in Tables 1-5, typically have a pH of about 7 to 9. Advantageously, the formulations shown in Tables 1-5 may have a pH of about 7.5 to 8.5. If necessary, a pH-adjusting agent may be added to the composition to achieve the desired pH range.

The present exemplary aqueous firefighting foam compositions, including the exemplary aqueous firefighting foam formulations shown in Tables 1-5, may have a viscosity of about 1,000 to 10,000 cps, in some instances about 1,000 to 5,000 cps and, in some embodiments, may desirably have a viscosity of about 1,000 to 2,500 cps (as determined at room temperature (75° F./24° C.) with a #4 spindle at 30 rpm).

### Method of Producing a Firefighting Foam

The firefighting foam concentrates described herein may be mixed with a diluent to form firefighting foam precursor solution, i.e., a use strength composition. The firefighting foam precursor solution may be aerated (e.g., using a nozzle) to produce a firefighting foam including the firefighting foam concentrate and the diluent. Exemplary diluents may include water, such as fresh water, brackish water, sea water, and combinations thereof. In some embodiments, the firefighting foam compositions described above may be 1 vol. %, 3 vol. %, or 5 vol. % concentrate solutions, meaning that the firefighting foam compositions are mixed with 99 vol. %, 97 vol. %, or 95 vol. % diluent, respectively, to form the firefighting foam precursor solution.

### Method of Fighting a Fire

The firefighting foam compositions described herein may be used to fight a Class B fire and/or to suppress flammable vapors by mixing the firefighting foam compositions with a diluent, aerating the resulting firefighting foam precursor solution to form a firefighting foam, and administering the firefighting foam to a fire or applying the firefighting foam to the surface of a volatile flammable liquid (e.g., gasoline or other flammable hydrocarbon or a flammable polar solvent).

### ILLUSTRATIVE EMBODIMENTS

Reference is made to a number of illustrative embodiments of the subject matter described herein. The following embodiments describe illustrative embodiments that may include various features, characteristics, and advantages of the subject matter as presently described. Accordingly, the following embodiments should not be considered as being comprehensive of all of the possible embodiments or otherwise limit the scope of the methods, materials, and compositions described herein.

In one illustrative embodiment, an aqueous fluorine-free, fire-fighting foam composition is provided. The fire-fighting foam composition includes about 5 to 20 wt. % monosaccharide sugar, about 5 to 15 wt. % alkyl sulfate anionic surfactant, about 2 to 10 wt. % alkylamidoalkyl hydroxysultaine surfactant, about 3 to 8 wt. % alkylene glycol, about 4 to 12 wt. % alkylene glycol monoalkyl ether, about 2 to 7 wt. % alkanolamine, about 0.2 to 3 wt. % magnesium salt. In some embodiments, the alkylamidoalkyl hydroxysultaine surfactant includes one or more C₈₋₁₄-alkylamidopropyl hydroxysultaine surfactants. In some instances, the alkyl sulfate anionic surfactant includes one or more C₈-C₁₄ alkyl sulfates. In some instances, the alkylamidoalkyl hydroxysultaine surfactant includes cocamidopropyl hydroxysultaine. Such a composition commonly does not contain any amine oxide or nonionic surfactant, or polysaccharide thickener.

In an illustrative embodiment, the aqueous firefighting foam composition includes a sugar component; anionic surfactant; zwitterionic surfactant; organic solvent comprising glycol ether and/or glycol solvent; and a polyol. The composition typically includes at least about 35 wt. % water. Optionally, the composition may also include alkanolamine. The sugar component commonly includes monosaccharide sugar and/or sugar alcohol. The surfactant component commonly does not contain any amine oxide or nonionic surfactant. In many instances, the composition comprises at least about 5 wt. % and, more commonly, about 5-20 wt. % of the sugar component. Quite often, the sugar component includes at least about 75 wt. % and, often, at least about 85 wt. % monosaccharide sugar and/or sugar alcohol. For example, the sugar component may include at least about 75 wt. % of one or more of glucose, fructose, mannose, xylose, xylitol, sorbitol, and mannitol. Typically, the composition is substantially free of fluorinated additives.

In another illustrative embodiment, the aqueous firefighting foam composition includes about 5 to 25 wt. % of a sugar component, which comprises at least about 75 wt. % monosaccharide sugar and/or sugar alcohol; about 5 to 15 wt. % anionic surfactant; about 3 to 18 wt. % zwitterionic surfactant; about 1 to 20 wt. % organic solvent; and at least about 30 wt. % water. The composition optionally includes about 1 to 10 wt. % alkanolamine. The surfactant component commonly does not contain any amine oxide or nonionic surfactant. The anionic surfactant may include one or more of an aliphatic sulfate salt, aliphatic sulfonate salt, an aliphatic ether sulfate salt, and aliphatic ether sulfate salt. The zwitterionic surfactant may include one or more of an alkylamidoalkyl betaine, an alkyl sulfobetaine, an alkylamidoalkyl hydroxysultaine, and an alkyl hydroxysultaine. The organic solvent may include one or more of a glycol, glycol ether, glycerol, and water-soluble polyethylene glycol (PEG). The composition is typically substantially free of fluorinated additives. The composition generally contains no more than 0.01 wt. % of a fluorinated additive.

In another illustrative embodiment, the aqueous firefighting foam composition includes about 5 to 20 wt. % of monosaccharide sugars and/or sugar alcohols; about 5 to 15 wt. % anionic surfactant, which comprises one or more of an aliphatic sulfate salt, aliphatic sulfonate salt, an aliphatic ether sulfate salt, and aliphatic ether sulfate salt; about 3 to 20 wt. % zwitterionic surfactant, which comprises one or more of an alkylamidoalkyl betaine, an alkyl sulfobetaine, an alkylamidoalkyl hydroxysultaine and an alkyl hydroxysultaine; about 3 to 25 wt. % organic solvent, which comprises one or more of a glycol, glycol ether, glycerol and/or water-soluble polyethylene glycol (PEG); and at least about 30 wt. % water. The composition is typically substantially free of fluorinated additives. The surfactant component commonly does not contain any amine oxide or nonionic surfactant.

In another illustrative embodiment, the aqueous firefighting foam composition includes about 5 to 22 wt. % of a mixture of glucose and fructose; about 5 to 18 wt. % of a C₈-C₁₄ alkyl sulfate anionic surfactant; about 1 to 15 wt. % of a C₈-C₁₄ alkylamidopropyl hydroxysultaine surfactant; about 5 to 22 wt. % of a mixture of ethylene glycol and butyl carbitol; about 0.1 to 5 wt. % glycerol; about 1 to 10 wt. % triethanolamine; and at least about 40 wt. % water. The surfactant component commonly does not contain any amine oxide or nonionic surfactant. Such a composition commonly contains no more than 0.01 wt. % fluorinated surfactants and is substantially free of nonionic surfactants.

In another illustrative embodiment, the aqueous firefighting foam composition includes at least about 10 wt. % of a sugar component, which comprises at least about 85 wt. % of one or more monosaccharide sugar and/or sugar alcohol; an anionic surfactant, a zwitterionic surfactant, an organic solvent comprising glycol ether having at least 8 carbon atoms and/or a polyol; and at least about 40 wt. % water. The surfactant component commonly does not contain any amine oxide or nonionic surfactant. Such a composition commonly contains no more than 0.01 wt. % fluorinated surfactants and is substantially free of nonionic surfactants. In such compositions, the organic solvent may include one or more of 1,6-hexanediol, hexylene glycol, ethyleneglycol monophenyl ether, butyl carbitol, ethylene glycol, glycerol, and dipropylene glycol monobutyl ether. In some instances, it may be advantageous to provide such a composition where the organic solvent does not contain any butyl carbitol.

In another illustrative embodiment, the aqueous firefighting foam composition includes about 7 to 20 wt. % of a sugar component which comprises one or more monosaccharide sugars and/or sugar alcohols; about 5 to 30 wt. % of a surfactant system comprising an anionic surfactant and a zwitterionic surfactant; about 3 to 25 wt. % of an organic solvent system comprising at least one organic solvent selected from a glycol ether, a glycol, a glycerol, and mixtures thereof; and at least about 40 wt. % water. Such compositions commonly contain no more than 0.01 wt. % fluorinated surfactants and are substantially free of nonionic surfactants. In some embodiments, the surfactant system may include cocamidopropyl hydroxysultaine and at least one of an octyl sulfate, a lauryl sulfate, and a decyl sulfate. In some embodiments, the surfactant system includes from about 3 to about 12 wt. % cocamidopropyl hydroxysultaine, from about 3 to about 15 wt. % decyl and/or lauryl sulfate, and from about 0.1 to about 3.0 wt. % glycerine. In some embodiments, the organic solvent system includes butyl carbitol, ethylene glycol, glycerine, or mixtures thereof. In some embodiments, the organic solvent system includes about 3 to 15 wt. % butyl carbitol, about 1 to 12 wt. % ethylene glycol, and about 0.1 to 3 wt. % glycerine. Some embodiments include a divalent metal salt, a preservative, or an antimicrobial agent. In some embodiments, the composition includes about 0.5 to 2 wt. % magnesium sulfate, about 0.05 to 0.2 wt. % preservative, and about 0.01 to 0.1 wt. % tolyltriazole.

In another illustrative embodiment, the aqueous firefighting foam composition includes about 5 to 20 wt. % of a sugar component which comprises one or more monosaccharide sugars and/or sugar alcohols; about 5 to 30 wt. % of a surfactant system comprising an anionic surfactant and a zwitterionic surfactant; about 5 to 25 wt. % of an organic solvent system comprising at least one organic solvent selected from a glycol ether, a glycol, a glycerol, and mixtures thereof; and at least about 40 wt. % water. Such compositions commonly contain no more than 0.01 wt. % fluorinated surfactants and are substantially free of nonionic surfactants.

In the illustrative embodiments above including an organic solvent, it may be beneficial to include one or more of 1,6-hexanediol, hexylene glycol, ethyleneglycol monophenyl ether, butyl carbitol and dipropylene glycol monobutyl ether. Those illustrative embodiments including an anionic surfactant may benefit from including one or more of a C₈₋₁₈-alkylamidopropyl hydroxysultaine surfactant, a C₈₋₁₈-alkylamidopropyl betaine surfactant a C₈₋₁₈-alkyl sulfobetaine surfactant and a C₈₋₁₈-alkyl betaine surfactant.

In another illustrative embodiment, a firefighting foam may be created by mixing any of the preceding firefighting foam composition and a diluent. The aqueous diluent may be selected from the group consisting of fresh water, brackish water, sea water, and combinations thereof.

Another illustrative embodiment comprises a method of forming a firefighting foam in which the method includes the steps of mixing the firefighting foam composition of any of the preceding illustrative embodiments with an aqueous diluent to form a foam precursor solution, and aerating the foam precursor solution to form the firefighting foam. In such a method the aqueous diluent may be selected from the group consisting of fresh water, brackish water, sea water, and combinations thereof.

Another illustrative embodiment is a method of fighting a fire, where the method includes the steps of administering the firefighting foam described in the preceding illustrative embodiments to the fire.

In the illustrative embodiments described above, it may be advantageous to provide an aqueous firefighting foam composition, which does not contain any protein hydrolysate. In some instances, it may be advantageous to provide an aqueous firefighting foam composition, which does not contain any synthetic polymer or copolymer. In some instances, it may be advantageous to provide an aqueous firefighting foam composition, which does not contain any non-biopolymeric thickening agent.

Para. 1. An aqueous fluorine-free, fire-fighting foam composition comprising: a sugar component; an aliphatic anionic surfactant; a zwitterionic surfactant; and a water-miscible organic solvent; wherein the composition is substantially free of any nonionic surfactant and polysaccharide thickener.

Para. 2. The composition of Para. 1, wherein the sugar component comprises monosaccharide sugar, a sugar alcohol, or a mixture of any two or more thereof.

Para. 3. The composition of Para. 1 or 2, wherein the sugar component comprises glucose, fructose, mannose, xylose, xylitol, sorbitol, mannitol, or a mixture of any two or more thereof.

Para. 4. The composition of any one of Paras. 1-3, wherein the composition comprises at least about 5 wt. % of the sugar component.

Para. 5. The composition of any one of Paras. 1-4, wherein the anionic surfactant comprises an aliphatic sulfate surfactant, an aliphatic sulfonate surfactant, an aliphatic succinate salt, an aliphatic ether sulfate surfactant, or a mixture of any two or more thereof.

Para. 6. The composition of any one of Paras. 1-5, wherein the anionic surfactant comprises C₈-C₁₄ alkyl sulfate, C₈-C₁₄ alkyl sulfonate, C₁₀-C₁₄ alkyl ether sulfate, or a mixture of any two or more thereof.

Para. 7. The composition of any one of Paras. 1-6, wherein the anionic surfactant comprises a C₈-C₁₄ alkyl sulfate, or a mixture of any two or more thereof.

Para. 8. The composition of any one of Paras. 1-7, wherein the anionic surfactant comprises a decyl sulfate salt, a lauryl sulfate salt, or a mixture of any two or more thereof.

Para. 9. The composition of any one of Paras. 1-8, wherein the composition comprises about 3 to 15 wt. % of the anionic surfactant.

Para. 10. The composition of any one of Paras. 1-9, wherein the zwitterionic surfactant comprises an aliphatic amidoalkyl betaine, an aliphatic sulfobetaine, an aliphatic amidoalkyl hydroxysultaine, an aliphatic hydroxysultaine, or a mixture of any two or more thereof.

Para. 11. The composition of any one of Paras. 1-10, wherein the zwitterionic surfactant comprises an aliphatic amidoalkyl hydroxysultaine.

Para. 12. The composition of any one of Paras. 1-11, wherein the zwitterionic surfactant comprises a C₈-C₁₄ alkyl amidopropyl hydroxysultaine, or a mixture of any two or more thereof.

Para. 13. The composition of any one of Paras. 1-12 comprising about 2 to 15 wt. % of the zwitterionic surfactant.

Para. 14. The composition of any one of Paras. 1-13, wherein the water-miscible organic solvent comprises a mixture of alkylene glycol and alkylene glycol monoalkyl ether.

Para. 15. The composition of any one of Paras. 1-14, wherein the water-miscible organic solvent comprises ethylene glycol and diethylene glycol monobutyl ether.

Para. 16. The composition of any one of Paras. 1-15, wherein the water-miscible organic solvent comprises ethylene glycol, diethylene glycol monobutyl ether, and glycerine.

Para. 17. The composition of any one of Paras. 1-16 comprising about 5 to 25 wt. % of the water-miscible organic solvent.

Para. 18. The composition of any one of Paras. 1-17 further comprising an alkanolamine.

19. The composition of Para. 18, wherein the alkanolamine comprises monoethanolamine, diethanolamine, diisopropanolamine, triethanolamine, or a mixture of any two or more thereof.

Para. 20. The composition of Para. 18 or 19, wherein the composition comprises about 1 to 10 wt. % of the alkanolamine.

Para. 21. The composition of any one of Paras. 1 to 20 further comprising a divalent metal salt.

Para. 22. The composition of Para. 21, wherein the divalent metal salt comprises a magnesium salt.

Para. 23. The composition of Para. 21 or 22 comprising about 0.2 to 3 wt. % of the magnesium salt.

Para. 24. The composition of any one of Paras. 1 to 23 further comprises a chelator, a buffer, a corrosion inhibitor, a preservative, or a mixture of any two or more thereof.

Para. 25. An aqueous fluorine-free, fire-fighting foam composition comprising: about 5 to 20 wt. % of a sugar component comprising monosaccharide sugar; about 5 to 15 wt. % alkyl sulfate anionic surfactant; about 2 to 10 wt. % alkylamidoalkyl hydroxysultaine surfactant; about 3 to 8 wt. % alkylene glycol; about 4 to 12 wt. % alkylene glycol monoalkyl ether; about 2 to 7 wt. % alkanolamine; and about 0.2 to 3 wt. % magnesium salt; wherein the composition is substantially free of any amine oxide surfactant, nonionic surfactant and polysaccharide thickener.

Para. 26. The composition of Para. 25, wherein the alkylamidoalkyl hydroxysultaine surfactant comprises a C₈₋₁₄-alkylamidopropyl hydroxysultaine surfactant, or a mixture of any two or more thereof.

Para. 27. The composition of Para. 25 or 26, wherein the alkyl sulfate anionic surfactant comprises an C₈-C₁₄ alkyl sulfate, or a mixture of any two or more thereof.

Para. 28. The composition of Para. 25, 26, or 27, wherein the alkylamidoalkyl hydroxysultaine surfactant comprises cocamidopropyl hydroxysultaine.

Para. 29. The composition of Para. 25, 26, 27, or 28, wherein the alkanolamine comprises triethanolamine.

Para. 30. An aqueous fluorine-free, fire-fighting foam composition comprising: about 5 to 20 wt. % glucose, fructose, or a mixture thereof; about 5 to 15 wt. % of a C₈-C₁₄ alkyl sulfate anionic surfactant, or a mixture of any two or more thereof, about 5 to 15 wt. % cocamidopropyl hydroxysultaine; about 3 to 8 wt. % ethylene glycol; about 4 to 12 wt. % diethylene glycol monobutyl ether; about 2 to 7 wt. % triethanolamine; and about 0.2 to 3 wt. % magnesium sulfate; wherein the composition is substantially free of any amine oxide surfactant, nonionic surfactant, and polysaccharide thickener.

Para. 31. An aqueous fluorine-free, fire-fighting foam composition comprising: a sugar component comprising glucose, fructose, or a mixture thereof; an anionic surfactant that is decyl sulfate, lauryl sulfate, or a mixture thereof, cocamidopropyl hydroxysultaine; ethylene glycol; diethylene glycol monobutyl ether; triethanolamine; and magnesium sulfate; wherein the composition is substantially free of any amine oxide surfactant, nonionic surfactant, and polysaccharide thickener.

Para. 32. An aqueous fluorine-free, fire-fighting foam composition comprising: a sugar component comprising a monosaccharide sugar, or a mixture of any two or more thereof; an alkyl sulfate anionic surfactant, or a mixture of any two or more thereof; an alkyl amidopropyl hydroxysultaines, or a mixture of any two or more thereof, an alkylene glycol; a dialkylene glycol monoalkyl ether; an alkanolamine; and a magnesium salt; wherein the composition is substantially free of any amine oxide surfactant, nonionic surfactant, and polysaccharide thickener.

Para. 33. The composition of Para. 1, wherein the water-miscible organic solvent comprises diethylene glycol monobutyl ether, ethylene glycol monophenyl ether, dipropylene glycol monobutyl ether, dipropylene glycol monomethyl ether, 1,6-hexanediol, ethylene glycol, hexylene glycol, propylene glycol, glycerine, or a mixture of any two or more thereof.

Para. 34. The composition of any one of Paras. 1 to 33, wherein the sugar component of the composition contains a total of no more than about 10 wt. % disaccharide sugars and oligosaccharides as a percentage of the total weight of all of the sugar components.

Para. 35. The composition of any one of Paras. 1 to 33, wherein the sugar component contains at least about 75 wt. % of one or more monosaccharide sugars as a percentage of the total weight of all of the sugar components.

Para. 36. The composition of any one of Paras. 1 to 35 further comprising a chelator, a buffer, a corrosion inhibitor, a preservative, or a mixture of any two or more thereof.

Para. 37. The composition of any one of Paras. 1 to 36 having a pH of about 7 to 9.

Para. 38. The composition of any one of Paras. 1 to 37 having a total of no more than about 0.01 wt. % fluorinated additives.

Para. 39. The composition of any one of Paras. 1 to 37 having a total concentration of fluorine atoms on a weight percentage basis of no more than about 1 ppm F.

Para. 40. The composition of any one of Paras. 1 to 37 comprising at least about 35 wt. % water.

Para. 41. The composition of any one of Paras. 1 to 24 which is substantially free of any amine oxide surfactants.

Para. 42. The composition of Para. 41 having a total of no more than about 0.01 wt. % amine oxide surfactants.

Para. 43. The composition of any one of Paras. 1 to 24 comprising a total of no more than about 0.01 wt. % of any amine oxide surfactant, nonionic surfactant, or polysaccharide thickener.

Para. 44. A method of forming a firefighting foam, the method comprising aerating a foam precursor composition comprising the aqueous fluorine-free, fire-fighting foam composition of any one of Paras. 1 to 43 to form the firefighting foam.

Para. 45. A method of forming a firefighting foam, the method comprising: mixing the firefighting foam composition of any one of Paras. 1 to 43 with an aqueous diluent to form a foam precursor solution; and aerating the foam precursor solution to form the firefighting foam.

Para. 46. The method of Para. 45, wherein the aqueous diluent is selected from the group consisting of fresh water, brackish water, sea water, and a combinations of any two or more thereof.

Para. 47. The method of Para. 45 or 46, wherein the aqueous diluent comprises water from a municipal water source.

Para. 48. A firefighting foam comprising the firefighting foam composition of any one of Paras. 1 to 43 and an aqueous diluent.

Para. 49. A method of fighting a fire comprising applying the firefighting foam of Para. 48 to the fire.

While certain embodiments have been illustrated and described, it should be understood that changes and modifications can be made therein in accordance with ordinary skill in the art without departing from the technology in its broader aspects.

The embodiments illustratively described herein may suitably be practiced in the absence of any element or elements, limitation or limitations, not specifically disclosed herein. Thus, for example, the terms “comprising,” “including,” “containing,” shall be read expansively and without limitation. Additionally, the terms and expressions employed herein have been used as terms of description and not of limitation, and there is no intention in the use of such terms and expression of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “and” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Additionally, where features or aspects of the disclosure are described in terms of Markush groups, those skilled in the art will realize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof.

1. An aqueous fluorine-free, fire-fighting foam composition comprising:
a sugar component comprising a monosaccharide sugar, a sugar alcohol, or a mixture of any two or more thereof;
an aliphatic anionic surfactant;
a zwitterionic surfactant; and
a water-miscible organic solvent;
wherein the composition is substantially free of any nonionic surfactant and polysaccharide thickener.

2. (canceled)

3. The composition of claim 1, wherein the sugar component comprises glucose, fructose, mannose, xylose, xylitol, sorbitol, mannitol, or a mixture of any two or more thereof.

4. The composition of claim 1, wherein the composition comprises at least about 5 wt. % of the sugar component, about 3 to 15 wt % of the anionic surfactant, about 2 to 15 wt. % of the zwitterionic surfactant, and about 5 to 25 wt. % of the water-miscible organic solvent.

5. (canceled)

6. The composition of claim 1, wherein the anionic surfactant comprises C₈-C₁₄ alkyl sulfate, C₈-C₁₄ alkyl sulfonate, C₁₀-C₁₄ alkyl ether sulfate, or a mixture of any two or more thereof.

7. (canceled)

8. The composition of claim 1, wherein the anionic surfactant comprises a decyl sulfate salt, a lauryl sulfate salt, or a mixture of any two or more thereof.

9. (canceled)

10. The composition of claim 1, wherein the zwitterionic surfactant comprises an aliphatic amidoalkyl betaine, an aliphatic sulfobetaine, an aliphatic amidoalkyl hydroxysultaine, an aliphatic hydroxysultaine, or a mixture of any two or more thereof.

11-13. (canceled)

14. The composition of claim 1, wherein the water-miscible organic solvent comprises a mixture of alkylene glycol and alkylene glycol monoalkyl ether.

15. The composition of claim 1, wherein the water-miscible organic solvent comprises ethylene glycol and diethylene glycol monobutyl ether.

16. The composition of claim 1, wherein the water-miscible organic solvent comprises ethylene glycol, diethylene glycol monobutyl ether, and glycerine.

17. (canceled)

18. The composition of claim 1 further comprising an alkanolamine selected from the group consisting of monoethanolamine, diethanolamine, diisopropanolamine, triethanolamine, or a mixture of any two or more thereof.

19. (canceled)

20. The composition of claim 18, wherein the composition comprises about 1 to 10 wt. % of the alkanolamine.

21. The composition of claim 1 further comprising a divalent metal salt.

22. (canceled)

23. The composition of claim 21 comprising about 0.2 to 3 wt. % of a magnesium salt.

24. (canceled)

25. An aqueous fluorine-free, fire-fighting foam composition comprising:
about 5 to 20 wt. % of a sugar component comprising monosaccharide sugar;
about 5 to 15 wt. % alkyl sulfate anionic surfactant;
about 2 to 10 wt. % alkylamidoalkyl hydroxysultaine surfactant;
about 3 to 8 wt. % alkylene glycol;
about 4 to 12 wt. % alkylene glycol monoalkyl ether;
about 2 to 7 wt. % alkanolamine; and
about 0.2 to 3 wt. % magnesium salt;
wherein the composition is substantially free of any amine oxide surfactant, nonionic surfactant, and polysaccharide thickener.

26-27. (canceled)

28. The composition of claim 25, wherein the alkylamidoalkyl hydroxysultaine surfactant comprises cocamidopropyl hydroxysultaine, and the alkanolamine comprises triethanolamine.

29-32. (canceled)

33. The composition of claim 1, wherein the water-miscible organic solvent comprises diethylene glycol monobutyl ether, ethylene glycol monophenyl ether, dipropylene glycol monobutyl ether, dipropylene glycol monomethyl ether, 1,6-hexanediol, ethylene glycol, hexylene glycol, propylene glycol, glycerine, or a mixture of any two or more thereof.

34. The composition of claim 1, wherein the sugar component of the composition contains a total of no more than about 10 wt. % disaccharide sugars and oligosaccharides as a percentage of the total weight of all of the sugar components.

35. The composition of claim 1, wherein the sugar component contains at least about 75 wt. % of one or more monosaccharide sugars as a percentage of the total weight of all of the sugar components.

36. The composition of claim 1 further comprising a chelator, a buffer, a corrosion inhibitor, a preservative, or a mixture of any two or more thereof.

37-43. (canceled)

44. A method of forming a firefighting foam, the method comprising aerating a foam precursor composition comprising the aqueous fluorine-free, fire-fighting foam composition of claim 1 to form the firefighting foam.

45-49. (canceled)
